(19) United States
(12) Patent Application Publication
(10) Pub. No.: US 2015/0278539 A1
(43) Pub. Date: Oct. 1, 2015

(54) LOCATION-BASED DATA SECURITY SYSTEM

(71) Applicant: Lucas G. Scarasso, Austin, TX (US)

(72) Inventor: Lucas G. Scarasso, Austin, TX (US)

(21) Appl. No.: 14/671,753

(22) Filed: Mar. 27, 2015

Related U.S. Application Data
(60) Provisional application No. 61/972,329, filed on Mar. 30, 2014.

(51) Int. Cl. G06F 21/62; G06F 21/86; G06F 21/79; G01S 19/13; H04L 9/08

(52) U.S. Cl. CPC G06F 21/6218; G01S 19/13; H04L 9/0897; G06F 21/79; G06F 21/86

(57) ABSTRACT

An apparatus for protecting data stored within a storage device from being accessed outside of previously defined geographic areas can comprise a storage module for storing data within a storage device. The apparatus can also comprise a location module for detecting a geographic location of the storage device. The device can further comprise a processing module for determining whether a detected geographic location is within a previously defined geographic area. Further still, the apparatus can comprise a first data security module in communication with the processing module. The first data security module can be configured to allow access to data stored within the storage module when the processing module determines that the detected geographic location is within the previously defined geographic area.

### CROSS-REFERENCE TO RELATED APPLICATIONS

This application claims priority to and the benefit of U.S. Provisional Application No. 61/972,329, filed on Mar. 30, 2014, entitled “A PROTECTION SYSTEM AND METHOD TO CONTROL PHYSICAL ACCESS AND ENCRYPTION ACCESS TO A STORAGE DEVICE BASED ON THE PHYSICAL LOCATION OF THE STORAGE DEVICE,” which is incorporated by reference herein in its entirety.

### BACKGROUND OF THE INVENTION

1. Technical Field

The present invention relates to digital data security.

2. Background and Relevant Art

In a world where information is increasingly stored digitally rather than on paper, it has become imperative to be able to protect sensitive information from being accessed from unauthorized users. Data can be protected by making the data difficult or impossible to read (e.g., encryption), by controlling digital user rights to the data, by controlling physical access to the data, or through any number of other schemes.

A particularly difficult aspect of data control relates to the mobility of modern storage devices. Conventional external storage devices, such as flash drives, external hard drives, and other similar devices, can carry tremendous amounts of data and can easily fit within an individual's pocket. These devices, and larger devices, can be easily misplaced, stolen, or otherwise lost.

One conventional method for protecting data on storage devices from being accessed is through the use of encryption. Encryption software uses an encryption key to obscure the data. Typically strong encryption keys render data undecipherable to all but the very most advanced organizations. Unfortunately, however, once unauthorized users have access to the encryption key they can easily gain access to the data.

While providing a strong layer of protection against illicit access, conventional encryption schemes have several difficulties and shortcomings. For example, encryption keys must be protected, while at the same time being available for proper users. Additionally, while encryption can prevent data from being interpreted, encrypted data—in its encrypted form—can still be copied from a device. Once removed from the device the encrypted data can be analyzed at other facilities and potentially cracked.

Accordingly, there is a need to systems that better protect digital data.

### BRIEF SUMMARY OF THE INVENTION

Implementations of the present invention comprise systems, methods, and apparatuses configured to only allow access to data when a storage device is located within a previously determined geographic area. In particular, implementations of the present invention comprise a storage device with integrated location detection modules. A processing module within the device can identify the geographic location of the storage device, and based upon the identified location, allow or block access to stored data.

Implementations of the present invention include a system for protecting data stored within a storage device from being accessed outside of previously defined geographic areas. The system can comprise a storage module for storing data within a storage device. The system can also comprise a location module for detecting a geographic location of the storage device. The system can further comprise a processing module for determining whether a detected geographic location is within a previously defined geographic area. Further still, the system can comprise a first data security module in communication with the processing module. The first data security module can be configured to allow access to data stored within the storage module when the a processing module determines that the detected geographic location is within the previously defined geographic area.

Additional implementations of the present invention can include a method for protecting data stored within a storage device from being accessed outside of previously defined geographic areas. The method can comprise detecting a connection of a storage device to an external computing device. The method can also comprise determining through one or more location-detection modules that are internal to the storage device whether the storage device is located within a previously defined geographic area. If the storage device is determined to be located within the previously defined geographic area, the method can comprise allowing data stored within the storage device to be accessed. In contrast, if the storage device is determined to not be within the previously defined data location area, the method can comprise preventing data stored within the storage device from being accessed.

Further implementations of the present invention can comprise a location-based data security storage device. The storage device can comprise a communication port for communicating data stored within a storage module to an external computing device. The storage device can also comprise a location module for detecting a geographic location of the storage device. Additionally, the storage device can comprise a processing module for determining whether a detected geographic location is within a previously defined geographic area. The storage device can also comprise a first data security module in communication with the processing module. The first data security module may be configured to allow access to data stored within the storage module when the processing module determines that the detected geographic location is within the previously defined geographic area.

Additional features and advantages of exemplary implementations of the invention will be set forth in the description which follows, and in part will be obvious from the description, or may be learned by the practice of such exemplary implementations. The features and advantages of such implementations may be realized and obtained by means of the instruments and combinations particularly pointed out in the appended claims. These and other features will become more fully apparent from the following description and appended claims, or may be learned by the practice of such exemplary implementations as set forth hereinafter.

### BRIEF DESCRIPTION OF THE DRAWINGS

In order to describe the manner in which the above recited and other advantages and features of the invention can be obtained, a more particular description of the invention briefly described above will be rendered by reference to specific embodiments thereof, which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates a schematic diagram of a storage device in accordance with implementations of the present invention;

FIG. 2 illustrates a circuit diagram of a storage device in accordance with implementations of the present invention;

FIG. 3 illustrates a flowchart of a method in accordance with implementations of the present invention; and

FIG. 4 illustrates another flowchart of a method in accordance with implementations of the present invention.

### DETAILED DESCRIPTION OF THE PREFERRED EMBODIMENTS

The present invention extends to systems, methods, and apparatuses configured to only allow access to data when a storage device is located within a previously determined geographic area. In particular, implementations of the present invention comprise a storage device with integrated location detection modules. A processing module within the device can identify the geographic location of the storage device, and based upon the identified location, allow or block access to stored data.

Accordingly, implementations of the present invention provide apparatuses, methods, and systems for securing data based upon a geographic location (e.g., a geo-fence). For example, in at least one implementation of the present invention, a company may desire to only have their data accessible on company premises. Using an implementation of the present invention the company can geographically define their premises as an area where data can be accessed. As such, the data would be inaccessible if someone attempted to access it in any other location.

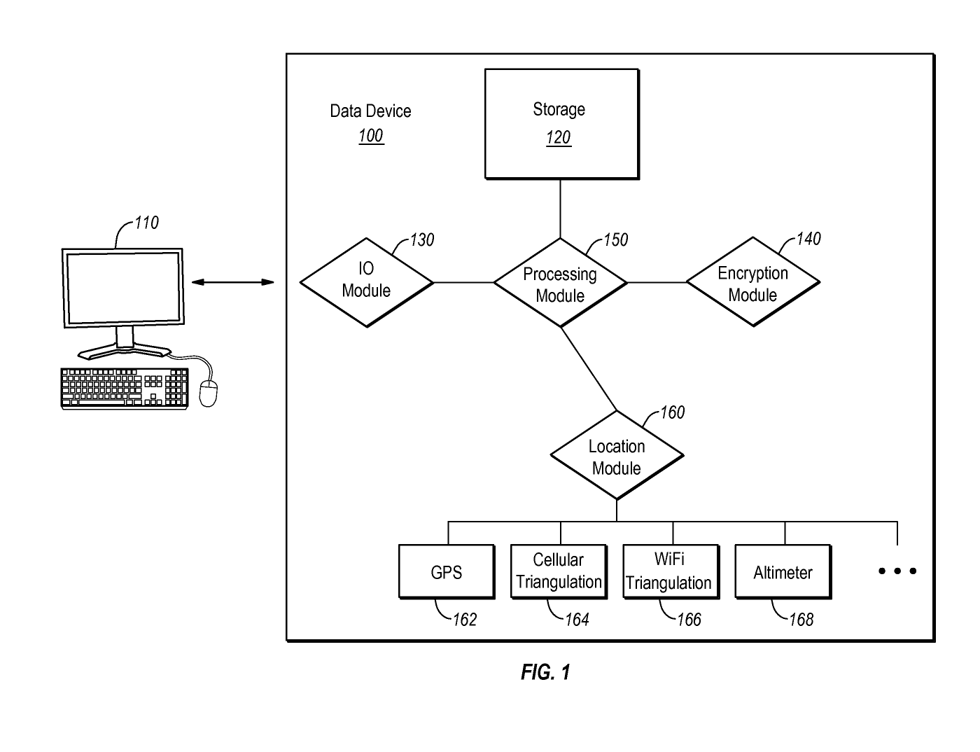

For example, FIG. 1 depicts a schematic diagram of a protected data device 100 in accordance with implementations of the present invention. The protected data device 100 may comprise a USB flash drive, an external Solid State Drive (“SSD”), an external platter-disk drive, an internal hard drive, an internal SSD, a computer tower, a computer server, a portable computer, a mobile computer, a smart phone, a tablet, or any other device capable of storing digital data. The protected data device 100 of FIG. 1 is depicted as a collection of modules. One will understand that the modules of FIG. 1 are provided for the sake of clarity and explanation and do not limit the present invention to a particular implementation. In particular, implementations of the present invention may be practiced with different combinations of modules than those depicted in FIG. 1. Specifically, modules may be otherwise combined, otherwise divided, or otherwise named and still fall within the meaning of the present invention.

FIG. 1 depicts an external computing device 110 in communication with the protected data device 100. The protected data device 100 can comprise an I/O module 130. In at least one implementation the I/O module 130 comprises necessary hardware and/or software components for implementing a communication standard. For example, in at least one implementation, the protected data device 100 and external computing device 110 are in communication through a USB connection. In alternate implementations, however, any number of different connections may be used. For example, and not by limitation, the external computing device 110 may be connected to the protected data device 100 through an eSATA connection, a FireWire connection, a Thunderbolt connection, an Ethernet connection, a wireless connection, a serial connection, a parallel connection, a fiber connection, or through any other connection used for communicating stored data.

The I/O module 130 can communicate with a processing module 150. As used herein, the processing module 150 may comprise a microcontroller, a CPU, discrete hardware components, software running on a processor, and/or other similar processing circuit components. The processing module 150 can be in communication with a storage module 120, an encryption module 140, and/or a location module 160. The storage module 120 may comprise Flash Memory, RAM, ROM, a hard drive, a Solid State Drive (“SSD”), or any other digital storage device.

In at least one implementation, upon detecting a connection to an external computing device 110, the I/O module 130 notifies the processing module 150 of the connection. Upon receiving an indication of a connected external computing device 110, the processing module 150 can query the location module 160 to determine a current geographic location of the protected data device 100.

The location module 160 may comprise one or more geographic location systems. The various geographic location systems may comprise a global navigation/positioning system (e.g., GPS system 162), a cellular triangulation system 164, a Wi-Fi triangulation system 166, an altimeter 168, and/or other similar location detection modules. In at least one implementation, the location module 160 can provide an exact geographic location of the protected data device 100. For example, a GPS module 162 may provide the location module 160 with the exact location of the protected data device 100 on the Earth's surface.

In contrast, in at least one implementation, the location module 160 can provide a relative location of the protected data device 100. For example, the cellular triangulation module 164 may not provide an exact location of the data protected data device 100 on the earth's surface. Instead, the cellular triangulation module 164 may simply confirm that the protected data device 100 is located within a previously specified geographic area.

For instance, when initially specifying a geographic area, the cellular triangulation module 164 may detect the identities and relative strengths of a plurality of different cellular signals from different cellular towers. While the cellular triangulation module 164 may not be aware of its location with respect to the entire earth, the cellular triangulation module 164 may be able to identify, based upon the previously detected and saved cellular signals, whether the protected data device 100 is located within a previously specified geographic area. For example, the cellular triangulation module 164 may be able to verify that it can detect the same cell towers at substantially the same power levels.

Additionally, in at least one implementation, the location module 160 can rely upon location data from multiple location detection systems. For example, the location module 160 may receive GPS coordinates from a GPS module 162 and altitude information from an altimeter 168. The location module 160 may be able to determine an altitude that should be associated with the detected GPS coordinates. The altitude may be determined from the received GPS signals or from a database of stored altitude values.

After receiving the GPS coordinates, the location module 160 can query the altimeter 168 to receive an altitude reading. The location module 160 can then compare the altitude from the altimeter reading with the altitude associated with the GPS coordinates. If the altitude information is consistent, the location module 160 can validate the location of the protected data device 100. In contrast, if the altimeter readings do not match the GPS altitude, the location module 160 can determine that the GPS readings may be erroneous or spoofed. In such a situation, the location module 160 would not validate the protected data device 100 as being located within a previously defined geographic area.

Based upon the information received from a location module 160, the processing module 150 can determine whether to give the external computing device 110 access to data within the storage module 120. In at least one implementation, if the location data does not match a predefined geographic area, no power is provided to the storage module 120. In at least one implementation, not providing power to the storage module 120 completely prevents the data from being accessed without physically disassembling the protected data device 100.

Additionally, in at least one implementation, the protected data device 100 comprises a filler, such as resin, to prevent an individual from physically tampering with the device. For example, the protected data device 100 may comprise an external shell configured to encase the device. The external shell may be filled with a hard material, such as resin, to prevent access to the individual components. The fill material may comprise a material with a melting point that is above a damaging heat threshold for the components of the protected data device 100. As such, removing the fill material through melting would irreparably destroy the components within the protected data device 100. Similarly, the fill material may comprise a hardness or tensile strength of such a magnitude that physically removing the fill material would destroy the components within the protected data device 100. Accordingly, one will understand, that not providing power to the storage module 120 provides significant protection against illicit access to data within the storage module 120.

In at least one implementation, the processing unit 150 can also be in communication with an encryption module 140. Based upon the detected location of the protected data device 100, the processing unit 150 can determine whether to provide an encryption key that is stored within encryption module 140. In at least one implementation, the encryption module comprises a portion of the processing module 150. In contrast, in at least one implementation, the encryption module 140 comprises a standalone circuit component configured to protect encryption keys. Additionally, in at least one implementation, the encryption key can be based, at least in part, upon geographical location data associated with a previously defined geographical area.

Additionally, in at least one implementation, the encryption module may comprise processing components that are configured to decrypt data. As such, in at least one implementation, if the processing module 150 determines that the particular data device 100 is located within a previously defined geographic area, the encryption module 140 can decrypt the data within the storage module 120 and present the decrypted data to the I/O module 130 for transmission to the external computing device 110.

In contrast, in at least one implementation, the encryption module 140 provides the encryption key 110 to the external computing device 110, so that the external computing device can decrypt the data that it receives. Accordingly, it may not be necessary for the protected data device 140 to be capable of encryption and decryption processes. One will understand, however, that in the case where the encryption module 140 decrypts the data, it is not necessary to provide the encryption key to the external computing device. In at least one implementation, it may be desirable to not share the encryption key with any external device—allowing the data stored with the protected storage device 100 to always remain undecipherable by external devices, unless the protected data device 100 itself decrypts the data.

As such, implementations of the present invention provide multiple layers of protection for data stored within a protected data device 100. In particular, implementations of the present invention prevent stored data from even being accessible by blocking power from going to the storage module 120 unless the device is detected as being within a previously defined geographic area. Additionally, implementations of the present invention can also prevent data from being decrypted unless the protected data device 100 is determined to be within a previously defined geographic region.

In at least one implementation, a user can define acceptable geographic areas in which data on the protected data device 100 can be accessed. In particular, in at least one implementation, a user can define multiple distinct geographic areas in which data on the protected data device 100 can be accessed. For example, in at least one implementation, when a protected data device 100 is first connected to an external computing device 110, a user is presented with options for defining geographic areas where data can be accessed. Specifically, a user may be presented with a software application that can be stored either on the protected data device 100 or on the external computing device 110 that is purpose built for defining geographic areas. A user may also be presented with hardware controls (e.g., knobs, buttons, etc.) on the outside of the protected data device 100 that are capable of adjusting the various described settings.

A user may be able to explicitly define an acceptable geographic area (herein also referred to as “previously defined geographic area”) using coordinates, a map interface (e.g., drawing the area on a map), the Public Land Survey System, some other geographic location system, or by ordering the protected data device 100 to self-identify its location. For example, the user can command the protected data device 100 to use one or more of its location systems to detect its present location. Additionally, the user can specify a threshold distance that defines the boundaries of the geographic area. As such, a user can explicitly define geographic boundaries or command the protected data device 100 to self-identify its current location as an acceptable geographic area.

Additionally, in at least one implementation, a password may be associated with the protected data device 100 that is required before a user can specify various settings for the protected data device 100. For example, using the password, a user may be able to specify geographic areas were data can be accessed, specify preferences relating to location detection modules, specify preferences related to encryption keys and encryption algorithms, and specify other similar user preferences. For instance, in at least one implementation, using the password, a user can specify a particular encryption key.

In at least one implementation, if a user enters the wrong password more than a threshold number of times, the data within the protected data device 100 is automatically erased by the processing module 150. For instance, the processing module 150 can erase the data by overwriting the data within the storage module 120 and/or erasing the encryption key. Similarly, in at least one implementation, the processing module 150 can also erase data within the data module 120 if an external computing device 110 attempts to access the data outside of a previously defined geographic area more than a threshold number of times.

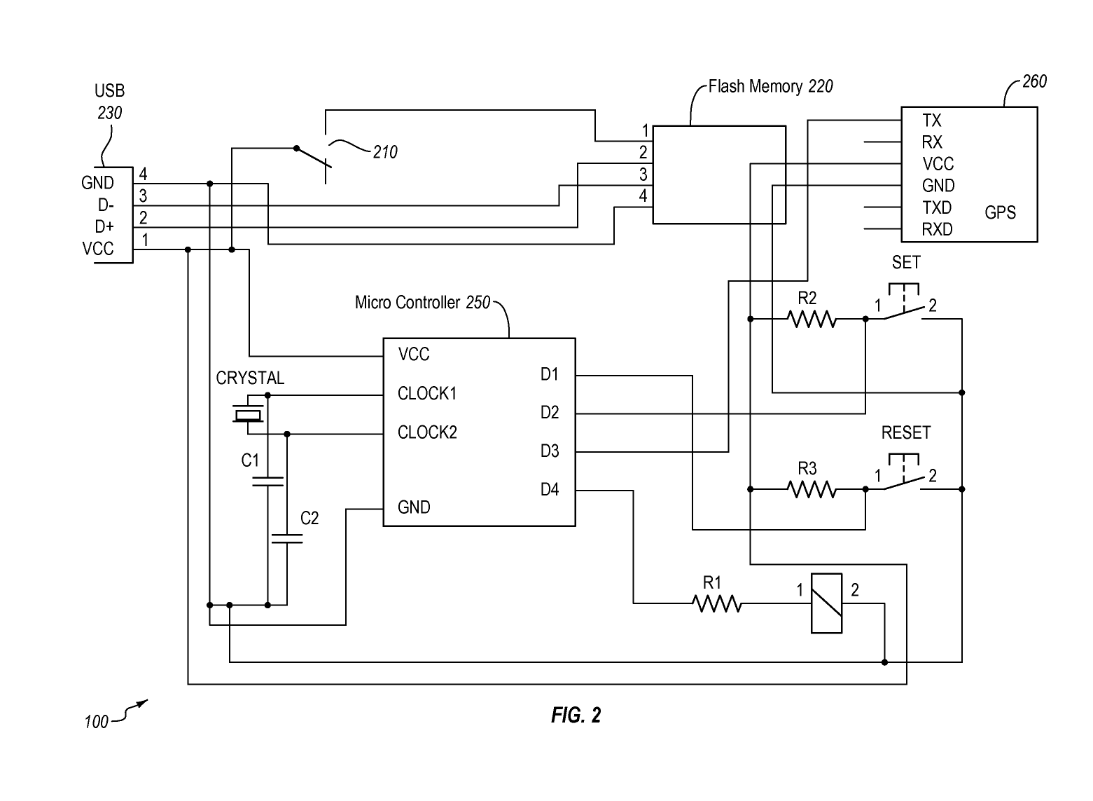

FIG. 2 depicts a circuit diagram of a protected data device 100 in accordance with an implementation of the present invention. In particular, FIG. 2 depicts a circuit diagram for preventing power from going to a flash memory component 220 unless the device is determined to be within a previously defined geographic area. The protected data device 100 of FIG. 2 comprises a USB port 230 for connecting to an external computing device 110. Additionally, the protected data device 100 comprises a microcontroller 250 that is in communication with the flash memory 220, the USB port 230, and a GPS module 260.

In at least one implementation upon being connected through the USB port 230 to an external computing device, the microcontroller 250 can query the GPS unit 260. The GPS unit 260 can then provide GPS coordinates to the microcontroller 250. The microcontroller 250 can determine if the GPS coordinates align with a previously defined geographic area. The locations and bounds of the previously defined geographic areas may be stored locally within the microcontroller 250, within a microcontroller memory module (not shown), or within an unencrypted portion of the flash memory module 220. If the microcontroller 250 determines that the protected data device 100 is located within a previously defined geographic area, the microcontroller 250 can cause a switch 210 to activate such that it creates a circuit between a power source and the flash memory 220. In at least one implementation, the switch 210 may comprise a solid state relay, a latching relay, an electromagnetic relay, and/or any other type of relay capable of selectively providing power to the flash memory 220. In contrast, if the microcontroller 250 determines that the protected data device 100 is not within a previously define geographic area, the microcontroller 250 can simply not send a command the cause the switch 210 to create a circuit.

As such, FIG. 2 depicts an implementation of the present invention that is configured to protect data stored within flash memory 220 from being accessible. In particular, implementations of the present invention only provide power necessary to access data stored within flash memory 220 if the device is determined to be within a previously defined geographic area. As such, an external computing device 110 is incapable of even reading the data stored within the protected data device 100.

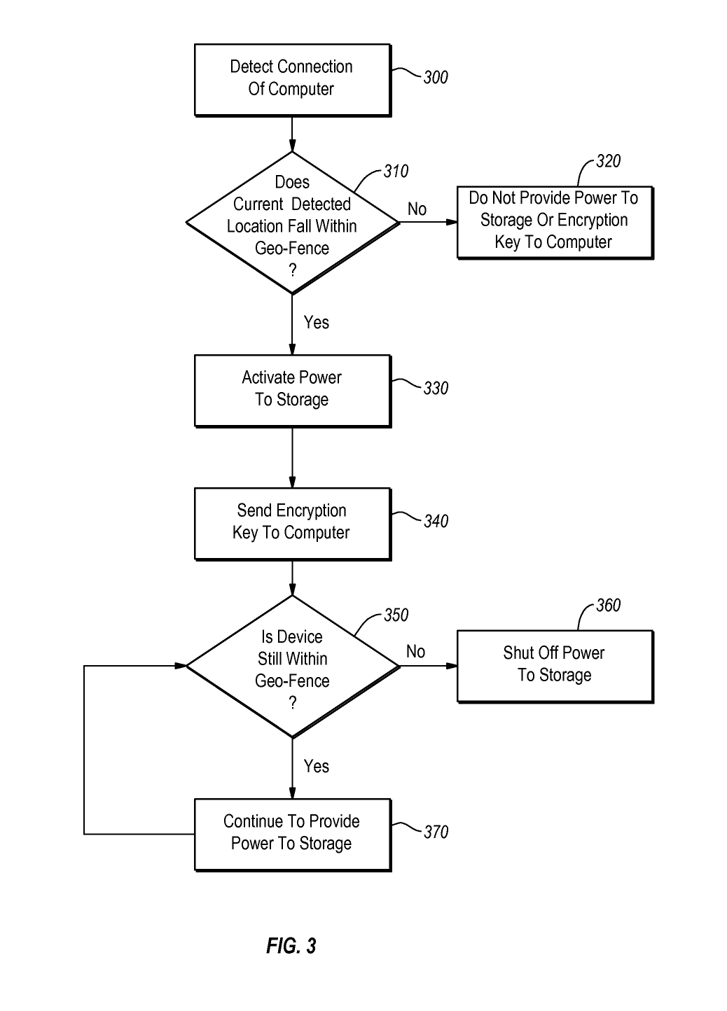

Turning now to a method of the present invention, FIG. 3 depicts a flowchart of a method for protecting data in accordance with implementations of the present invention. In particular, FIG. 3 shows that the method can comprise a step 300 of detecting a connection of a computer to a protected data device 100. Once a computer connection is detected, FIG. 3 shows that a step 310 comprises determining whether the current detected location falls within a previously defined geo-fence area.

In the case the currently detected location does not fall within a geo-fenced area, step 320 does not provide power to the storage module or an encryption key for decrypting the data. In contrast, in the case that the current detector location does fall within a previously geo-fenced area, step 330 activates power to a storage module. Step 340 then sends an encryption key to an external computing device so that external computing device can decrypt received data.

Additionally, step 350 continues to determine periodically whether the device is still within the previously defined geo-fenced area. In particular, at a set period, a processing module can request an updated location from a location module. If it is determined that the device is still within a previously defined geo-fenced area step 370 continues to provide power to the storage module. In contrast if the device is no longer within the previously defined geo-fenced area, step 360 shuts off power to the storage module. Accordingly implementations of the present invention both protect data on initial access and continue to protect data by updating and monitoring the current location of the protected data device 100.

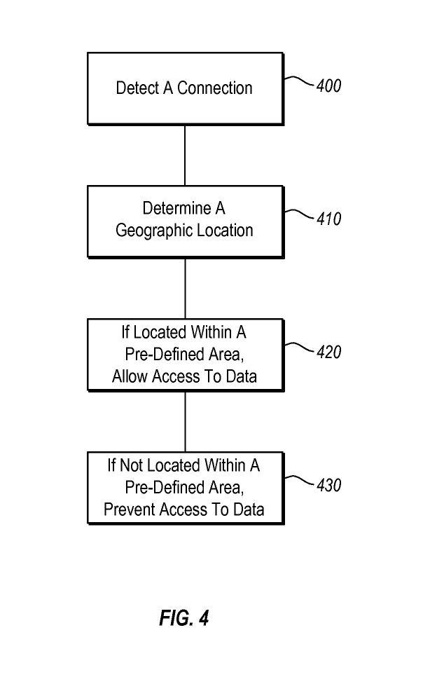

Accordingly, FIGS. 1-3 and the corresponding text illustrate or otherwise describe one or more methods, systems, and/or instructions protecting data stored on a digital storage medium. One will appreciate that implementations of the present invention can also be described in terms of methods comprising one or more acts for accomplishing a particular result. For example, FIG. 4 and the corresponding text illustrate a flowchart of a sequence of acts in a method for protecting data within a protected data device 100. The acts of FIG. 4 are described below with reference to the components and modules illustrated in FIGS. 1-3.

For example, FIG. 4 illustrates that a flow chart for an implementation of a method for protecting data stored within a storage device from being accessed outside of previously defined geographic areas can comprise an act 400 of detecting a connection. Act 400 can include detecting a connection of a storage device to an external computing device. For example, in FIG. 1 and the accompanying description, the processing module 150 detects, through the I/O module 130, when an external computing device 110 is connected to the protected data device 100.

FIG. 4 also shows that the method can comprise an act 410 of determining a geographic location. Act 410 includes determining through one or more location-detection modules that are internal to the storage device whether the storage device is located within a previously defined geographic area. For example, in FIG. 1, and the accompanying description, the location module 160 query a GPS module 162 to determine the current location of the protected data device 100. The location module 160 and/or the processing module 150 can then determine whether the detected location is within a previously defined geographic area.

Additionally, FIG. 4 shows that the method can comprise an act 420 of allowing data stored within the storage device to be accessed, if the storage device is a determined to be located within the previously defined geographic area. For example, in FIG. 2, and the accompanying description, if the microcontroller 250 determines that location data received from the GPS unit 260 is consistent with a previously defined geographic area, the microcontroller can activate a switch 210 that provides power to the flash memory 220. Once the flash memory 220 receives power, the external computing device may be able to access stored data through the USB interface 230.

Further, FIG. 4 shows that the method can comprise an act 430 of preventing data stored within the storage device from being accessed, if the storage device is determined to not be within the previously defined data location area. For example, in FIG. 1, and the accompanying description, the processing unit 150 can prevent power from going to the storage module if the protected data device 100 is determined to not be within a previously defined geographic area. Similarly, the processing unit 150 can prevent the encryption module 140 from decrypting data or providing an encryption key to an external computing device 110 if the device is determined to be outside of a previously defined geographic region.

Accordingly, implementations of the present invention provide significant benefits for protecting data. In particular, implementations of the present invention can maintain data in encrypted form, unless the protected data device is located within a previously defined geographic region. Additionally, implementations of the present invention can prevent a memory module from receiving power, and thus prevent an external computer from even accessing stored data, unless the protected data device is located within a previously defined geographic region. Further, implementations of the present invention provide methods for allowing a user to specify various preferences and features relating to the security of the user's data.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

Embodiments of the present invention may comprise or utilize a special-purpose or general-purpose computer system that includes computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, embodiments of the invention can comprise at least two distinctly different kinds of computer-readable media: computer storage media and transmission media.

Computer storage media are physical storage media that store computer-executable instructions and/or data structures. Physical storage media include computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can include a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be included within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may include a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of“cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some embodiments, such as a cloud-computing environment, may comprise a system that includes one or more hosts that are each capable of running one or more virtual machines. During operation, virtual machines emulate an operational computing system, supporting an operating system and perhaps one or more other applications as well. In some embodiments, each host includes a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

I claim:

1. A method for protecting data stored within a storage device from being accessed outside of previously defined geographic areas, the method comprising:
detecting a connection of a storage device to an external computing device;
determining through one or more location-detection modules that are internal to the storage device whether the storage device is located within a previously defined geographic area;
if the storage device is determined to be located within the previously defined geographic area, allowing data stored within the storage device to be accessed; and
if the storage device is determined to not be within the previously defined data location area, preventing data stored within the storage device from being accessed.

2. The method as recited in claim 1, further comprising:
receiving, at the storage device, an indication defining a geographic area; and
storing the defined geographic area within the storage device.

3. The method as recited in claim 2, further comprising:
receiving, at the storage device, one or more indications defining multiple, distinct geographic areas; and
storing the defined multiple, distinct geographic areas within the storage device.

4. The method as recited in claim 1, further comprising:
receiving initial location information from a first location-detection module;
receiving additional location information from a second, different location-detection module;
comparing the additional location information with the initial location information; and
determining that the additional location information and the initial location information are consistent with each other.

5. The method as recited in claim 4, wherein the first location-detection module is selected from a group consisting of a satellite based navigation system, a cellular triangulation system, a Wi-Fi triangulation system, and an altimeter.

6. The method as recited in claim 5, wherein the second, different location-detection module is selected from a group consisting of a satellite based navigation system, a cellular triangulation system, a Wi-Fi triangulation system, and an altimeter.

7. The method as recited in claim 1, further comprising:
receiving initial location information from a satellite based navigation system;
receiving altitude information from an altimeter;
comparing the altitude information with an expected altitude associated with the initial location information; and
determining that the altitude is consistent with the initial location information.

8. The method as recited in claim 1, further comprising:
if the storage device is determined to not be within the previously defined data location area, deleting data stored within the storage device.

9. The method as recited in claim 1, further comprising:
receiving, through an antenna within the storage device, information from one or more broadcasting sources;
based upon the received information, triangulating a location of the storage device; and
comparing the received location information to a location associated with the previously defined geographic area.

10. The method as recited in claim 1, further comprising:
if the storage device is determined to be located within the previously defined geographic area, providing power to a storage portion of the storage device, such that data can be accessed from the storage device.

11. The method as recited in claim 10, further comprising:
if the storage device is determined to be located within the previously defined geographic area, providing an encryption key, stored within the storage device, that decrypts data stored within the storage device.

12. The method as recited in claim 11, wherein encrypted data stored within the storage device is decrypted by a processing module within the storage device.

13. The method as recited in claim 11, wherein the encryption key is provided to the external computing device so that the external computing device can decrypt data stored within the storage device.

14. A location-based data security storage device, the storage device comprising:
a communication port for communicating data stored within a storage module to an external computing device;
a location module for detecting a geographic location of the storage device;
a processing module for determining whether a detected geographic location is within a previously defined geographic area; and
a first data security module in communication with the processing module, wherein the first data security module is configured to allow access to data stored within the storage module when the processing module determines that the detected geographic location is within the previously defined geographic area.

15. The storage device as recited in claim 14, further comprising multiple location modules.

16. The storage device as recited in claim 14, wherein the location module is selected from a group consisting of a satellite based navigation system, a cellular triangulation system, a Wi-Fi triangulation system, and an altimeter.

17. The storage device as recited in claim 14 wherein the first data security module comprises a power coupling switch that connects the storage module with a power source, wherein the power coupling switch is controlled by the processing module.

18. The storage device as recited in claim 14 wherein the first data security module comprises an encryption module that stores an encryption key for encrypted data stored within the storage module, wherein the encryption module is controlled by the processing module.

19. The storage device as recited in claim 14 further comprising a resin filler, wherein the resin filler is configured to prevent tampering with the storage device.

20. A system for protecting data stored within a storage device from being accessed outside of previously defined geographic areas, the system comprising:
a storage module for storing data within a storage device;
a location module for detecting a geographic location of the storage device;
a processing module for determining whether a detected geographic location is within a previously defined geographic area; and
a first data security module in communication with the processing module, wherein the first data security module is configured to allow access to data stored within the storage module when the processing module determines that the detected geographic location is within the previously defined geographic area.
